(19) United States
(12) Patent Application Publication
(10) Pub. No.: US 2022/0154853 A1
(43) Pub. Date: May 19, 2022

(54) Gasketed Pipe Support System

(71) Applicants: Yulman Flores, Houston, TX (US); Wallace Cogbill, Vidor, TX (US)

(72) Inventor: YULMAN Manuel FLORES, Houston, TX (US)

(21) Appl. No.: 17/531,030

(22) Filed: Nov. 19, 2021

Related U.S. Application Data
(60) Provisional application No. 63/115,923, filed on Nov. 19, 2020.

(51) Int. Cl. F16L 3/10; F16L 3/12; F16L 3/26

(52) U.S. Cl. CPC F16L 3/105; F16L 3/1025; F16L 3/26; F16L 3/1211; F16L 3/1041

(57) ABSTRACT

A pipeline support device and a gasketed pipeline supporting system is disclosed. The pipeline support device comprises a gasket, a gasket support, and one or more bands. The gasket support provides support to the gasket. The gasket receives a pipe to be supported and the pipe is enclosed using the one or more bands on the gasket. The gasket is made of a resilient compressible material to provide high durability and long-life. The gasketed pipeline supporting system provides a pipeline support device and system with improved corrosion resistance and monitoring capabilities.

### CROSS-REFERENCE TO RELATED APPLICATIONS

This application claims priority to provisional application Ser. No. 63/115,923, titled “GASKETED PIPING SUPPORT SYSTEM”, filed Nov. 19, 2020, which is incorporated herein in its entirety by reference.

### FIELD OF INVENTION

This present disclosure generally relates to pipeline support systems. More particularly, the present disclosure relates to a pipeline support device and a system thereof.

### BACKGROUND OF THE INVENTION

Various mechanical means have been proposed to support pipelines above ground. A common feature of previous pipeline support devices is a cradle atop a vertical support extending from the ground. A common problem associated with previous pipeline support devices is corrosion between the cradle and pipeline. Such corrosion can compromise pipeline integrity and increase maintenance costs. Some earlier proposed systems employ epoxy that exclude moisture from the pipeline-cradle interface, however, the integrity of epoxy installation can be subject to installer error. Accordingly, improvements are sought in excluding moisture from pipeline-cradle interfaces.

### SUMMARY OF THE INVENTION

While the way that the present disclosure addresses the disadvantages of the prior art will be discussed in greater detail below, in general, the present disclosure provides a pipeline support device providing a compression seal at the pipeline-device interface to exclude moisture.

The pipeline support device in accordance with the present disclosure comprises a gasket, a gasket support, and one or more bands. The gasket has a predetermined length and a predetermined curvature. The predetermined curvature of the gasket corresponds to a pipe of a pipeline being supported by the device. The gasket may be compressible.

The gasket support is configured to provide support to the gasket. The gasket support has a length and a curvature corresponding to the gasket. In an embodiment, the gasket support is configured to have beveled edges. The gasket support comprises one or more slots.

The one or more bands are configured to be received by the one or more slots of the gasket support. The one or more bands are configured to enclose a pipe placed on the gasket using one or more tightening elements, thereby providing support to the pipe.

The gasket is made of resilient compressible material. In some embodiments, the gasket material comprises rubber.

The pipeline support device comprises one or more sensors. The one or more sensors are configured to measure parameters associated with the pipe and the pipeline.

The present disclosure further discloses a gasketed pipeline supporting system. The system in accordance with the present disclosure comprises a pipeline support device, at least one processor, and one or more user devices. The pipeline support device comprises a gasket, a gasket support and one or more bands, and is configured to provide support to a pipe by enclosing of the pipe by the one or more bands. The pipeline support device is further configured to generate one or more signals based on a current condition of working of the pipe. The at least one processor is in communication with the pipeline support device using a communication network. The at least one processor is configured to receive the one or more signals generated by the pipeline support device and generate a notification signal based on the current condition of working of the pipe. The one or more user devices are in communication with the at least one processor using the communication network. Each of the one or more user devices is associated with one or more user interfaces. The one or more user devices are configured to receive the notification signal from the at least one processor on the associated user interface.

The pipeline support devices of the present disclosure are a heavy-duty composite solution for eliminating metal-to-metal contact and external corrosion in piping systems.

The pipeline support devices use a composite banding system and a waterproof gasket to eliminate the potential of corrosion causing moisture traps. This eliminates the potential of a faulty installation.

The pipeline support devices require no pipe surface preparation (on new pipe), no cure time, removability for inspection in the future and reduced labor costs (approximately half the overall cost).

The pipeline support devices can be configured with multiple gasketing options to meet specific applications.

The pipeline support devices use a resilient composite banding system and compressible gasket to eliminate the need of careful pipe surface preparation and epoxy cure time. The installation of the pipeline support device is simple and easy.

The gasket of the pipeline support device is a resilient closed-cell silicone that conforms to the pipe surface to create a waterproof seal. The gasket is operable is at temperatures of −60 to 570 F. The gasket may be made of long-life materials, such as Silicone, PTFE, EPDM, PVC. The gasket may further be made using specific chemical resistant materials.

Some advantages of the gasket of the present disclosure are as follows:
Eliminates the need for perimeter epoxy seal.
Eliminates the possibility of moisture traps.
Suitable for harsh environments.

Some advantages of the one or more bands are as follows:
Low Profile tightening elements
High Strength up to 5,793LBF
Long-life materials
Safe and easy to fit.
High speed installation.
High retention force
Suitable for subsea use.

In some embodiments, a pipeline support device includes a passive, wired, or wireless sensor to provide support and local pipeline specific data collection and sensing.

The pipeline support device provides improved corrosion resistance, improved monitoring, and improved service life.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures, and

FIG. 1 illustrates an exemplary perspective top view of a pipeline support device in accordance with an embodiment of the present disclosure;

FIG. 2 illustrates an exemplary side view of the pipeline support device of FIG. 1;

FIG. 3 illustrates an exemplary front-end view of the pipeline support device of FIG. 1;

FIG. 4 illustrates an exemplary top perspective view of a pipeline support device having a passive sensor;

FIG. 5 illustrates an exemplary top perspective view of a pipeline support device having a wired sensor;

FIG. 6 illustrates an exemplary top perspective view of a pipeline support device having a wireless sensor; and

FIG. 7 illustrates an exemplary gasketed pipeline supporting system in accordance with an embodiment of the present disclosure.

### LIST OF REFERENCE NUMERALS

Components referenced herein include:
100—pipeline support device
102—gasket
104—gasket support
106—one or more bands
108—processor
110—user device
112—communication network
122—passive sensor
124—wired sensor
126—wireless sensor
142—one or more slots
144—beveled edges
162—one or more tightening elements

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, sealing mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

In the following description, certain terminology is used to describe certain features of one or more embodiments of the invention. For example, the term “support” as described herein may include, but is not necessarily limited to, a vertical strut and a cradle. The support may be constructed from a wide variety of materials including, but not necessarily limited to, metal, composites, plastics, etc.

Traditionally, non-metallic wear pads are used to prevent external corrosion on pipes due to contact with a support structure. They are adhered and sealed to the pipe permanently with epoxy. The pad and epoxy prevent moisture traps and wear on the pipe surface which prevents corrosion. However, the quality of the epoxy layer is highly reliable on the technician. The risk of failure is dependent on the amount of epoxy used. Further, installation and cure time of such pipeline support systems is very high. The cure time alone is around 24 hrs. Further, the process of installation of such systems is messy and is unusable in cold weather. Furthermore, in order to remove such support systems, the epoxy must be broken into pieces. Moreover, such systems are not readily removable or reusable.

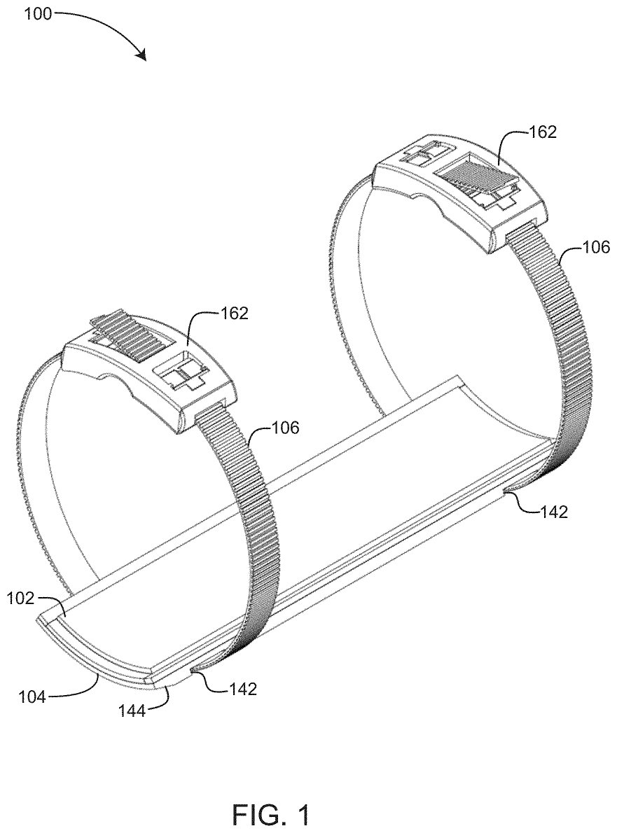

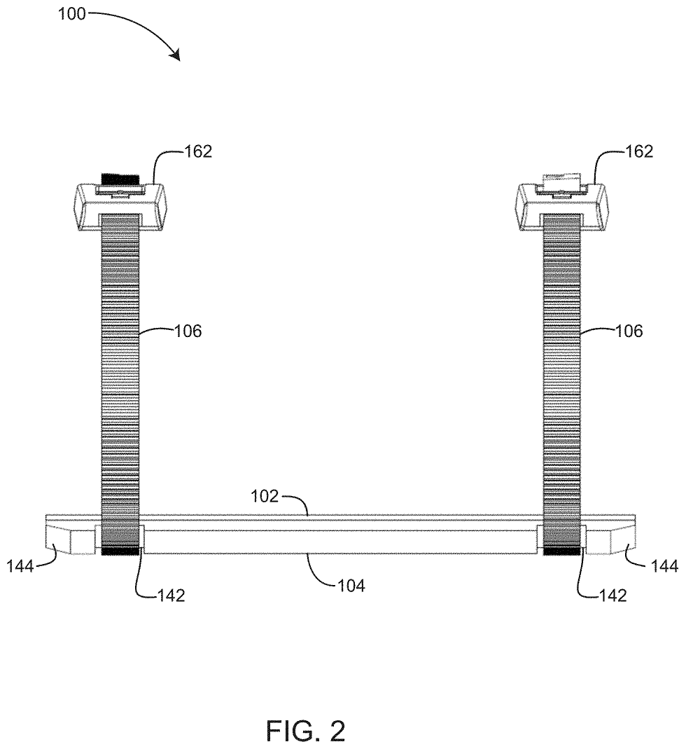

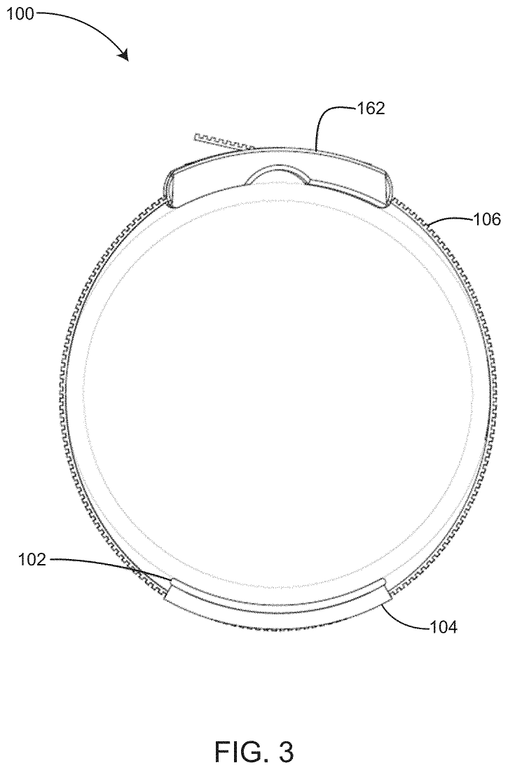

To overcome such limitations of the existing systems, the present disclosure provides a pipeline support device and a gasketed pipeline support system. FIG. 1 illustrates a perspective top view of an exemplary pipeline support device 100 in accordance with the present disclosure. The pipeline support device 100 comprises a gasket 102, a gasket support 104, and one or more bands 106. FIG. 2 illustrates a side view of the pipeline support device 100 of FIG. 1. FIG. 3 illustrates a front-end view of the pipeline support device 100 of FIG. 1. As seen in FIGS. 1-3, the gasket 102 is configured to have a predefined length and a predefined curvature. The predefined length and the predefined curvature of the gasket 102 depend on a size of the pipe (not shown) to which a support needs to be provided. It is to be noted that the length and the curvature of the gasket may vary as per requirement without departing from the sense and scope of the present disclosure.

The gasket 102 is compressible and is made of a resilient, closed-cell silicone material or rubber that conforms to the pipe's surface to create a waterproof seal. The gasket 102 eliminates the need for careful pipe surface preparation and epoxy cure time. Further, the gasket 102 eliminates a potential for corrosion caused by trapped moisture. Hence, the corrosion between the pipe and the gasket 102 reduces, which results in long durable time for the pipeline support device. Additionally, as there is no corrosion, any fault caused by the corrosion is avoided in the pipeline support device 100 of the present disclosure.

The gasket support 104 is configured to provide support to the gasket 102. The gasket support 104 corresponds to the gasket 102 in that the gasket support 104 is configured to have a length and a curvature corresponding to the gasket 102 to provide accurate support to the gasket 102, and hence, to the pipe to which the gasket 102 is coupled.

The gasket 102 is configured to be received by the gasket support 104 on an upper surface of the gasket support 104. In an embodiment, edges 144 of the gasket support 104 are beveled. The beveled edges 144 provide smooth transition at the edges of the gasket support 104 to allow for smooth transitions of the gasketed support over the beam or support structure.

The gasket support 104 comprises one or more slots 142 configured to receive one or more bands 106. In an embodiment, the slots 142 may be provided in pairs on either side surfaces of the gasket support 104 so as to allow a band 106 to be received and held by a pair of slots 142. The one or more bands 106 are thus configured to be received and held by corresponding one or more slots 142 of the gasket support 104. The one or more bands 106 are configured to be tightened once a pipe is placed on the gasket 102. The pipeline support device 100 comprises one or more tightening elements 162 configured to tighten the one or more bands 106.

In a non-limiting embodiment, the tightening elements 162 are buckles. When a pipe is placed on the gasket 102, the one or more bands 106 are disposed in the corresponding one or more slots 142 in the gasket support 104 and the one or more bands 106 are tightened around the pipe using corresponding one or more tightening elements 162 so as to at least partially enclose the pipe and provide support to the pipe. In other words, the one or more bands 106 surround the pipe around a circumference of the pipe.

Although a single pipeline support device 100 is illustrated in FIGS. 1-3, it is appreciated that multiple pipeline support devices 100 can be arranged over a length of a pipe, thereby providing support to the pipe as multiple portions thereof.

In some embodiments, the pipeline support device 100 comprises one or more sensors. The one or more sensors may be provided on or adjacent the gasket 102 of the pipeline support device 100. The one or more sensors are configured to detect various parameters associated with the pipe to which the pipeline support device 100 is coupled to as well as parameters associated with a pipeline formed by an arrangement of pipes. Some non-limiting examples of the detected parameters are vibrations, leakage in the pipe due to chemical reactions, temperature of the pipe, and the like. In some embodiments, the one or more sensors are passive sensors.

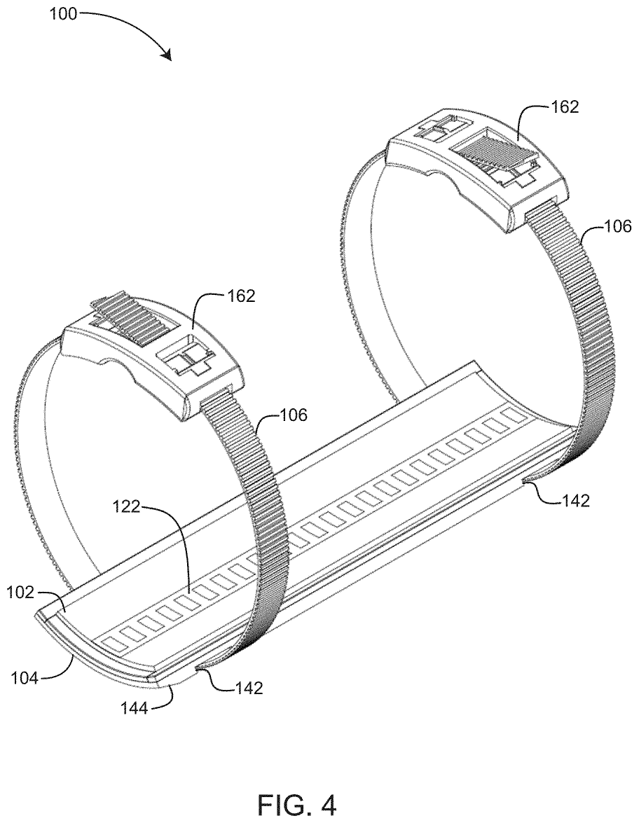

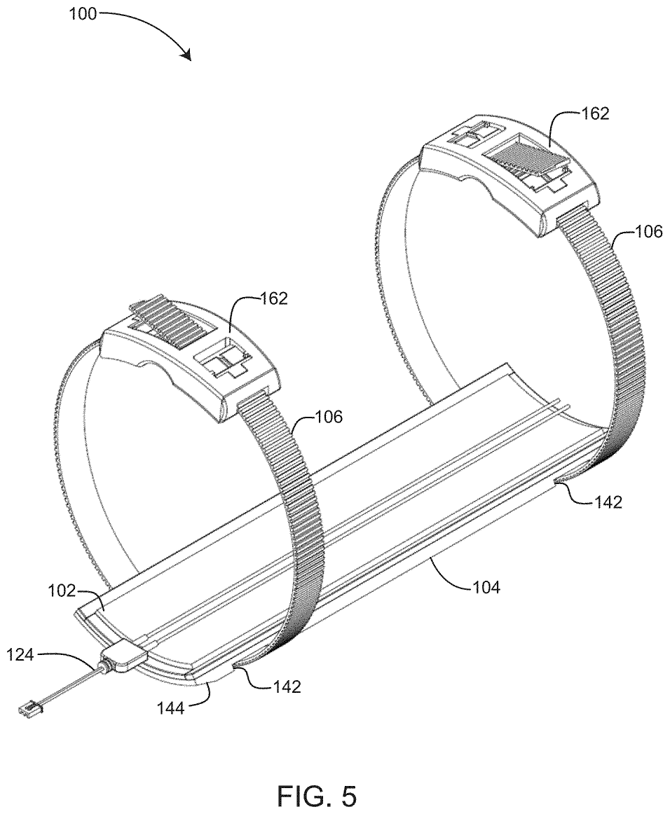

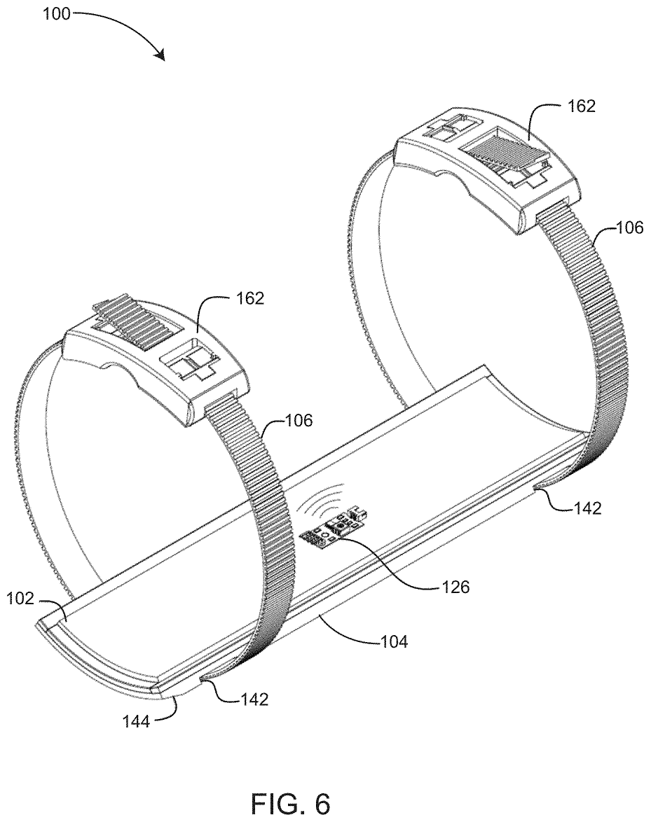

FIG. 4 illustrates the pipeline support device 100 comprising a passive sensor 122 embedded into the gasket 102. In some embodiments, the one or more sensors are wired sensors and/or wireless sensors. FIG. 5 illustrates the pipeline support device 100 comprising a wired sensor 124 embedded into the gasket 102 while FIG. 6 illustrates the pipeline support device 100 comprising a wireless sensor 126 embedded into the gasket 102.

In an embodiment, the wireless sensor 126 may be an RFID sensor. In such embodiment, an RFID tag may be attached to the gasket 102 and an RFID reader may be installed in user devices (not shown). The RFID readers may be stationary or mobile. The user device may be a mobile phone, a desktop computer, or laptop computer, and the like. The RFID tag may further include pipeline information to be sent along with the one or more detected parameters. The pipeline information may include, but not limited to, an identification number, a location of the pipeline, material carried by the pipeline, and the like. Such pipeline parameters and pipeline information are sent to the user devices. A user, an administrator, or a technician may act appropriately based on the received pipeline information and pipeline parameters.

The pipeline support device 100 of the present disclosure is easy to install and reusable. To reuse the pipeline support device 100 in a same pipeline, the one or more bands 106 can be loosened from the corresponding one or more tightening elements 162 and can be tightened at another portion on the previous pipe or at a different pipe of the pipeline as per where a support is required.

The pipeline support device 100 in accordance with the present disclosure is easy to install and maintain. The installation time of the pipeline support device 100 is around 3 minutes, which is significantly less as compared to the traditional epoxy based pipeline support systems. Further, the pipeline support device 100 can be easily uninstalled and reused at another place in the pipeline, such as at a different portion of the pipe or at a different pipe from the previous pipe. This also results in reduced labor cost as highly skilled person are not always required for installation and uninstallation of the pipeline support device 100. Moreover, the gasket is made of resilient compressible material, which makes the device long lasting. The pipeline support device 100 is operative between temperature range of −60° F. to 570° F. The device 100 ensures peak performance in the most demanding environments such as marine, off-shore, and other highly corrosive environments.

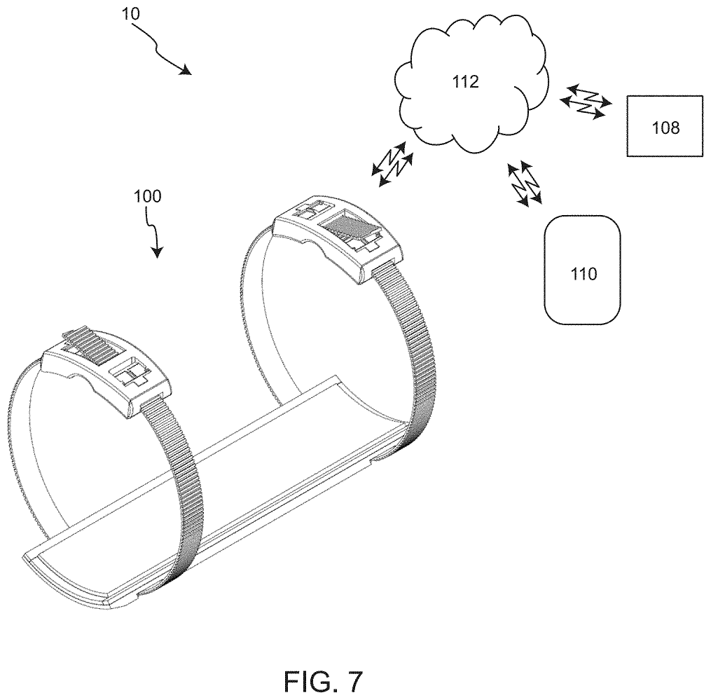

FIG. 7 illustrates an exemplary gasketed pipeline supporting system 10 in accordance with the present disclosure. The system 10 comprises a pipeline support device 100, at least one processor 108, and one or more user devices 110. It is to be noted that the pipeline support device 100 of the system 10 may be any of the device as described hereinabove with reference to FIGS. 1-6 and comprises all the components thereof. Further, although a single pipeline support device 100 is illustrated in FIG. 7, it is appreciated that the gasketed pipeline supporting system 10 may include multiple pipeline support devices 100 in any combination of the pipeline support devices described with reference to FIGS. 1-3, 4, 5, and 6.

Accordingly, the pipeline support device 100 comprises a gasket 102, a gasket support 104, and one or more bands 106. The pipeline support device 100 is configured to support a pipe of a pipeline. The pipeline support device 100 may further comprise one or more sensors embedded therewithin (not shown in FIG. 7). The one or more sensors are configured to detect one or more parameters of the pipe and generate corresponding one or more signals based on a current condition of the pipe. The one or more parameters detected by the one or more sensors comprise, but not limited to, vibration, leaks in the pipe due to chemical reactions, temperature of the pipe, and the like.

The at least one processor 108 is configured to be in communication with the pipeline support device 100 using a communication network 112. The communication network may be a wired network or wireless network such as Internet, Intranet, PSTN, Local Area Network (LAN), Wide Area Network (WAN), Metropolitan Area Network (MAN), and so forth. The at least one processor 108 is configured to receive the one or more generated signals from the pipeline support device 100. The at least one processor 108 generates a notification signal based on the received one or more signals based on the current condition of working of the pipe. In some embodiments, the notification signal comprises an identification number of the pipeline, a location of the pipeline, material carried by the pipeline, and the like. In an embodiment, the notification signal is indicative of normal working of the pipe. In another embodiment, the notification signal is indicative of a fault in the pipe. The fault may be indication of a leak in the pipe, over heating of the pipe, more vibration detected in the pipe, and the like. In such embodiment, the at least one processor 108 is configured to generate an alert signal indicating the fault.

The at least one processor 108 may represent a unit, or a plurality of interconnected units, that is configured to implement a plurality of functionalities. The processor may be programmed using software (e.g., microcode) to perform various tasks. It is appreciated that the processor may include a central processing unit (CPU), a graphics processing unit (GPU), a microcontroller, a processing core, a field-programmable gate array (FPGA), or similar devices capable of executing instructions.

In some embodiments, the at least one processor 108 is part of a server (not shown) to provide the plurality of functionalities of the system 10 to a user. Some non-limiting examples of the functionalities are issuing alerts to specific technicians, managers and upper management, resetting the alarm after resolving the fault, generating reports of working of the pipeline on at a predetermined time. The predetermined time may be daily, weekly, monthly, quarterly, or selected time ranges. The system further includes a non-transitory computer readable storage medium which comprises instructions executable by the at least one processor to perform the plurality of functionalities. The computer readable medium may comprise any electric, magnetic, optical, or other physical storage device that stores executable instructions.

The one or more user devices 110 are in communication with the at least one processor 108 using the communication network 112. Each of the one or more user devices 110 is associated with a user interface. Each of the one or more user devices 110 is configured to receive the notification signal and the alert signal generated by the at least one processor 108. In an embodiment, the user device 110 may include the processor 108.

A technician may monitor a current condition of working of the pipe based on the received notification signal. If the alert signal is received by the one or more user devices, then, the technician, on receiving the alert signal, may take precautionary steps to resolve the fault. After resolving the fault, the technician may further monitor normal working of the pipe on a user interface of any one of the one or more user devices 110. In some exemplary embodiments, the one or more user interfaces of the one or more user devices 110 may facilitate a user or a technician to perform the plurality of functionalities in communication with the server such as issue alerts to specific managers and upper management, to generate reports on working of the pipeline daily, weekly, monthly, quarterly, or selected time ranges, and reset the alarm after resolving the fault. Some non-limiting examples of the one or more user devices 110 include laptop and desktop computers, smartphones, tablets, and the like.

The gasketed pipeline supporting system in accordance with the present disclosure provides a pipeline support device and system with improved corrosion resistance and monitoring capabilities.

While the present disclosure has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. A pipeline support device comprising:
a gasket;
a gasket support for supporting the gasket, the gasket support corresponding to the gasket, the gasket support comprising one or more slots; and
one or more bands configured to be received by the one or more slots of the gasket support, the one or more bands configured to at least partially enclose a pipe of a pipeline placed on the gasket, thereby providing support to the pipe.

2. The pipeline support device of claim 1, wherein the gasket has a predetermined length and a predetermined curvature, and the gasket support has a length and curvature substantially corresponding to the length and curvature of the gasket.

3. The pipeline support device of claim 1, wherein the pipeline support device comprises one or more tightening elements configured to facilitate the one or more bands to support the pipe.

4. The pipeline support device of claim 2, wherein the predetermined curvature of the gasket corresponds to a curvature of the pipe placed on the gasket.

5. The pipeline support device of claim 1, wherein the gasket support is configured with beveled edges.

6. The pipeline support device of claim 1, wherein the gasket is made of a resilient compressible material.

7. The pipeline support device of claim 1, wherein the gasket is compressible.

8. The pipeline support device of claim 1, comprising one or more sensors configured to measure parameters associated with the pipe and/or the pipeline.

9. The pipeline support device of claim 8, wherein the one or more sensors are passive sensors.

10. The pipeline support device of claim 8, wherein the one or more sensors are any one of wired sensors and wireless sensors.

11. The pipeline support device of claim 10, wherein the one or more sensors are RFID sensors, the RFID sensors being configured to sense the parameters and transmit the sensed parameters.

12. The pipeline support device of claim 8, wherein the one or more sensors are configured to transmit pipeline information associated with the pipe of the pipeline, the pipeline information comprising an identification number of the pipeline, a location of the pipeline, and material carried by the pipeline.

13. The pipeline support device of claim 1, wherein the device is operative between temperature range of −60° F. to 570° F.

14. The pipeline support device of claim 1, wherein the device is configured to be sepreused.

15. A gasketed pipeline supporting system, the system comprising:
a pipeline support device comprising a gasket, a gasket support, and one or more bands, the pipeline support device configured to provide support to a pipe of a pipeline by at least partially enclosing of the pipe by the one or more bands, the pipeline support device configured to generate one or more signals associated with parameters of the pipe;
at least one processor in communication with the pipeline support device, the at least one processor configured to receive the one or more signals generated by the pipeline support device and further configured to generate a notification signal based on received one or more signals; and
one or more user devices in communication with the at least one processor, the one or more user devices configured to receive the notification signal from the at least one processor.

16. The system of claim 15, wherein the pipeline support device comprises one or more sensors configured to detect the parameters of the pipe, thereby generating one or more signals.

17. The system of claim 15, wherein the generated notification signal is indicative of normal working of the pipe.

18. The system of claim 15, wherein the generated notification signal is indicative of a fault in the pipe.

19. The system of claim 18, wherein the at least one processor is configured to generate an alert signal if the notification signal indicates the fault in the pipe and transmit the alert signal to the one or more user devices.

20. The system of claim 15, wherein the notification signal comprises an identification number of the pipeline, a location of the pipeline, material carried by the pipeline.
